(19) United States
(12) Patent Application Publication
(10) Pub. No.: US 2025/0154978 A1
(43) Pub. Date: May 15, 2025

(54) Release Mechanism For Friction Locks of a Telescoping Shaft

(71) Applicant: Never-Thought-of-It LLC, Island Pond, VT (US)

(72) Inventor: Thomas Kurzej, Island Pond, VT (US)

(21) Appl. No.: 18/922,733

(22) Filed: Oct. 22, 2024

Related U.S. Application Data
(60) Provisional application No. 63/597,371, filed on Nov. 9, 2023.

(51) Int. Cl. F16C 3/03; B25G 1/04

(52) U.S. Cl. CPC F16C 3/03; B25G 1/04

(57) ABSTRACT

A mechanism for releasing friction locks of a telescoping shaft, in which the locks are formed by swaged outer ends of each preceding member of the shaft and flared inner ends of each following member provides a guided axial impact to the end member of the shaft. This mechanism for releasing friction locks in telescoping shafts allows the release of the locks to be more comfortably and accurately accomplished for users than by striking an end of the shaft against a hard surface, such as a concrete wall or pavement.

### RELATED APPLICATION DATA

This application claims the benefit of priority of U.S. Provisional Patent Application Ser. No. 63/597,371, filed Nov. 9, 2023, and titled Mechanism for Releasing Friction Locks of a Telescoping Shaft, which is incorporated by reference herein in its entirety.

### FIELD OF THE DISCLOSURE

The present invention generally relates to telescoping shafts. In particular, the present invention is directed to a mechanism for releasing friction locks of a telescoping shaft.

### BACKGROUND

Deadlocked friction locks between tubular members of a telescoping shaft may be formed by swaged outer ends of each preceding member and flared inner ends of each following member and can be released by a sharp axial blow to the end of the shaft's last member, thus causing the retraction of all friction-locked members of the shaft.

### SUMMARY OF THE DISCLOSURE

A telescoping shaft with a collapsed configuration and an extended configuration includes a plurality of members forming the telescoping shaft that are lockable in the extended configuration by a plurality of friction locks, a rod configured to be received within an endmost member of the plurality of members, wherein the rod's configurations include an extended position and a retracted position, and an object attached to a distal end of the rod. When the rod is moved from the extended position to the retracted position with sufficient rapidity, the object strikes the endmost member with sufficient force to unlock the plurality of friction locks.

In another embodiment, a telescoping shaft with a collapsed configuration and an extended configuration includes a plurality of members forming the telescoping shaft that are lockable into the extended configuration by a plurality of respective friction locks, a rod configured to be received within an endmost member of the plurality of members, wherein the rod includes a stop at a proximal end and wherein the rod includes an object attached to a distal end of the rod, and a tension spring between the distal end and the proximal end of the rod. When the rod is moved from a retracted position to an extended position, the stop engages with a portion of the endmost member and the tension spring stretches such that upon release, the rod moves into the endmost member to the retracted position causing the object to strike the endmost member with sufficient force to release the plurality of friction locks.

In another embodiment, a telescoping shaft with a collapsed configuration and an extended configuration includes a plurality of members forming the telescoping shaft that are lockable into the extended configuration by a plurality of friction locks, a rod configured to be received within an endmost member of the plurality of members, wherein the rod includes an object attached to a distal end of the rod, and a compression spring between the distal end and a proximal end of the rod. When the rod is moved from a retracted position to an extended position, the compression spring engages with a portion of the endmost member such that upon release, the rod moves into the endmost member to the retracted position causing the object to strike the endmost member with sufficient force to release the plurality of friction locks.

### BRIEF DESCRIPTION OF THE DRAWINGS

For the purpose of illustrating the disclosure, the drawings show aspects of one or more embodiments of the disclosure. However, it should be understood that the present disclosure is not limited to the precise arrangements and instrumentalities shown in the drawings, wherein:

FIG. 1A is a side perspective view of a telescoping shaft in an extended state in accordance with an embodiment of the disclosure;

FIG. 1B is a side perspective view of the telescoping shaft of FIG. 1A in the extended state with a rod extended;

FIG. 1C is a side perspective view of the telescoping shaft of FIG. 1A in a collapsed state;

FIG. 2 is an exploded view of the telescoping shaft of FIG. 1A;

FIG. 3A is a side cross section view of the telescoping shaft of FIG. 1A in the extended state;

FIG. 3B is a side cross section view of the telescoping shaft of FIG. 1A in the extended state with the rod extended;

FIG. 3C is a side cross section view of the telescoping shaft of FIG. 1A in the collapsed state;

FIG. 4A is a side perspective view of a telescoping shaft in an extended state in accordance with another embodiment of the disclosure;

FIG. 4B is a side perspective view of the telescoping shaft of FIG. 4A in the extended state with a rod extended;

FIG. 4C is a side perspective view of the telescoping shaft of FIG. 4A in a collapsed state;

FIG. 5 is an exploded view of the telescoping shaft of FIG. 4A;

FIG. 6A is a side cross section view of the telescoping shaft of FIG. 4A in the extended state;

FIG. 6B is a side cross section view of the telescoping shaft of FIG. 4A in the extended state with the rod extended;

FIG. 6C is a side cross section view of the telescoping shaft of FIG. 4A in the collapsed state;

FIG. 7 is an exploded view of a telescoping shaft of in accordance with another embodiment of the present disclosure;

FIG. 8A is a side cross section view of the telescoping shaft of FIG. 7 in the extended state;

FIG. 8B is a side cross section view of the telescoping shaft of FIG. 7 in the extended state with the rod extended; and

FIG. 8C is a side cross section view of the telescoping shaft of FIG. 7 in the collapsed state.

### DETAILED DESCRIPTION

A mechanism for releasing friction locks of a telescoping shaft, in which the locks are formed by swaged outer ends of each preceding member of the shaft and flared inner ends of each following member, is disclosed which provides a guided axial impact to the end member of the shaft. This mechanism for releasing friction locks in telescoping shafts allows the release to be more comfortably and accurately accomplished for users than by striking an end of the shaft against a hard surface, such as a concrete wall or pavement.

The friction locks are released as the result of an axial impact by an object having a relatively substantial mass attached to the end of a rod slidably positioned within the shaft's last (endmost) tubular member that is held in an extended position by a friction lock. The object may be a handle, knob, or other component attached to a rod slidably positioned within that last member along the member's central axis. In a preferred embodiment, the rod is kept from completely leaving the shaft's last member either by a spring and a stop formed by the narrowing of the last member's inside diameter, or just by the stop. The rod's position in the member's central axis assures that the impact with that object (e.g., a handle) is axial, i.e., along that member's central axis, and thus along the whole shaft's central axis. The impact may be initiated by the release of tension or compression of a spring (depending on the type of spring included in the last tubular member is attached to the rod) previously tensed or compressed by an operator's pull on the handle, or by a quick push with an operator's hand on the pulled out handle (in the case without a spring).

In an exemplary embodiment, an object, e.g., a handle, with sufficient rigidity and mass to effectively release the friction locks of a telescoping shaft when the object strikes the end of the shaft under the conditions described, is attached to a rod slidably positioned within a shaft's last tubular member, and is aligned along the member's central axis. The rod is kept retracted into the shaft's last tubular member by a compression spring or a tension spring placed inside the member and attached to the rod, and a stop, which may be formed by a narrowing of the last member's inside diameter and thus prevents the rod from completely leaving the shaft's last member. The stop engages the rod's tail end which has an outside diameter greater than the diameter of the opening in the stop. The rod's position in the member's central axis assures that the impact with the object (e.g., a handle) is axial, i.e., along that member's central axis, and thus along the whole shaft's central axis. The impact may be facilitated by releasing tension or compression of a spring (depending which kind of spring placed inside the last tubular member is attached to the rod) previously tensed or compressed by an operator's pull on the handle.

In an alternative, the rod with an object attached to one end may be kept in a retracted position or extended position into/out of the last member of the shaft by a ball-catch lock or other suitable mechanism. The ball catch may have two positions to engage in, the rod's retracted position and the rod's extended position. In this embodiment, the axial impact of the object against the shaft is accomplished by unlocking the ball catch (from either the extended or retracted position) such that the rod can move freely along the shaft's longitudinal central axis within the last member and, with the rod in the extended position, applying a quick push with an operator's hand.

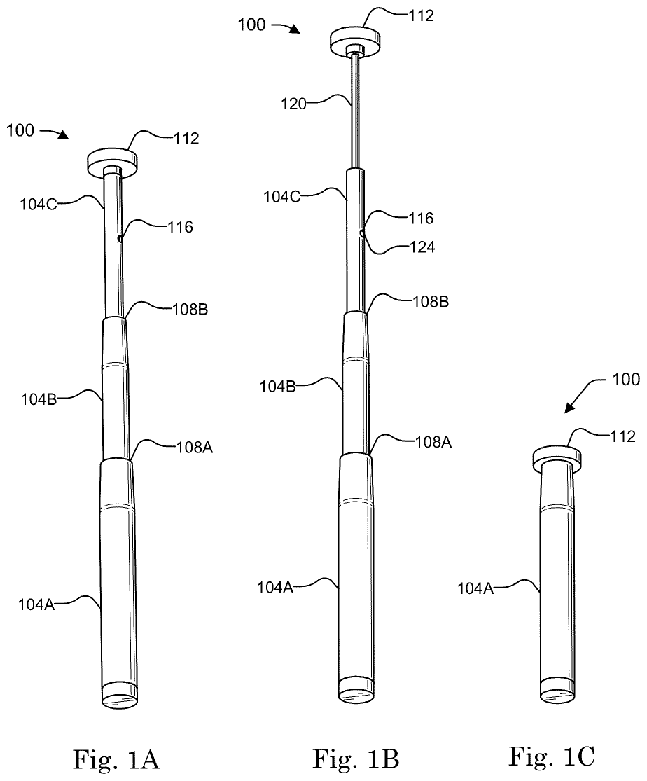

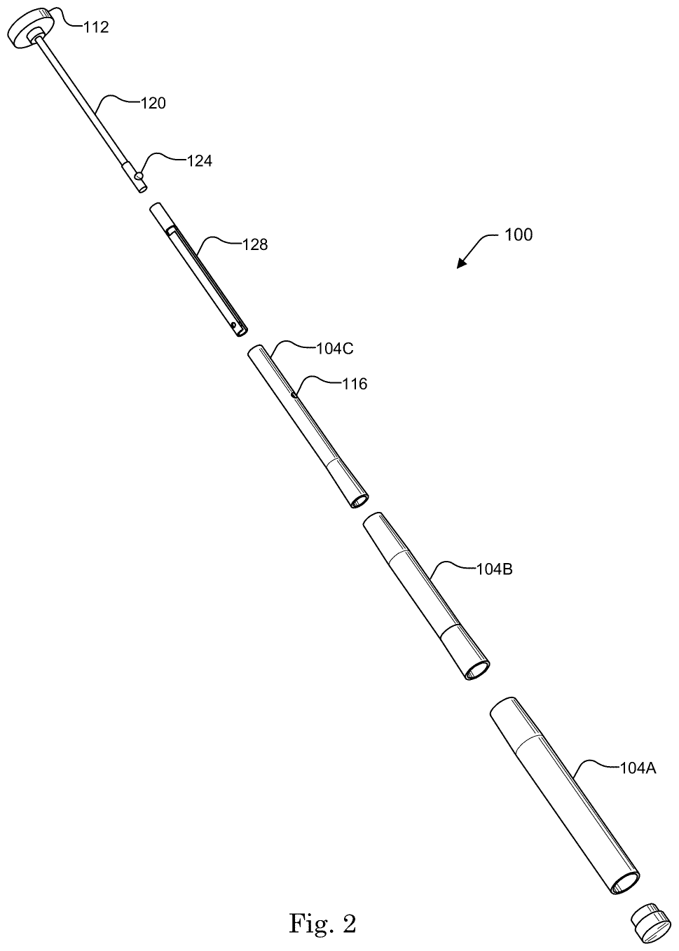

Turning to the figures, FIGS. 1A-3C show a telescoping shaft 100 having a plurality of tubular members 104 (e.g., 104A-104C) that are held in an extended configuration by a plurality of friction locks 108 (e.g., 108A, 108B). Endmost member 104C may also include a hole 116 for engaging a ball of a ball-catch lock.

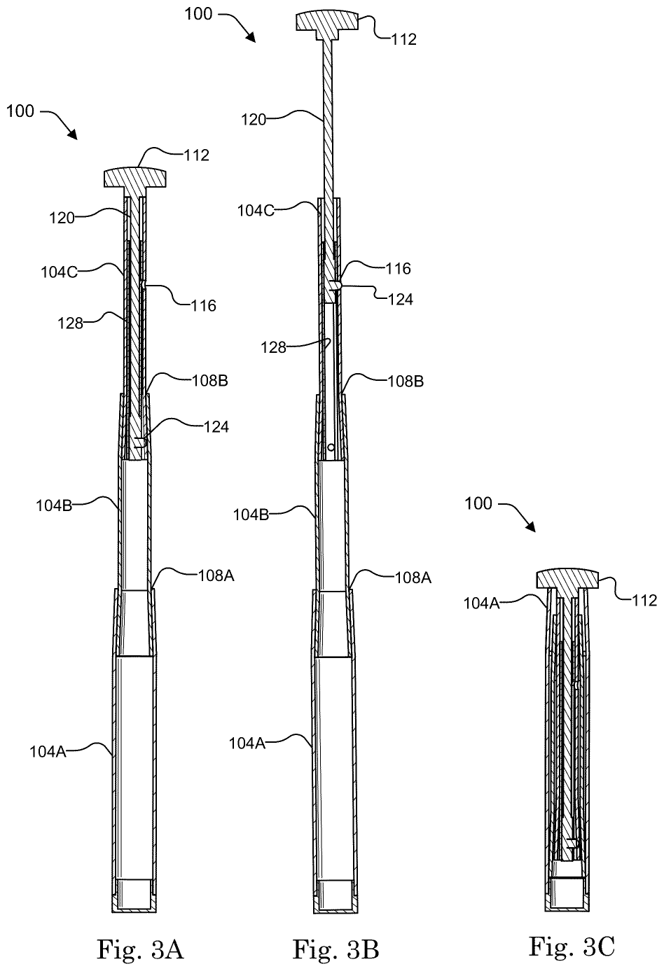

As can be seen in FIG. 1B, handle 112 is attached to a rod 120 that is extendable from and retractable into endmost member 104C along an axial axis of shaft 100. Rod 120 may also include a ball-catch lock 124 configured to engage with hole 116 to secure rod 120 in a retracted position or extended position, depending on the location of hole 116. A guide 128 (as shown in FIGS. 3A-3C) may be included within endmost member 104C for receiving and guiding rod 120 along the shaft's longitudinal central axis when rod 120 is pushed in. In this way, when the ball-catch lock is released, rod 120 is free to move axially within endmost member 104C and can be extended outward from endmost member 104C along with attached handle 112. Rod 120 can then also move freely into guide 128 and endmost member 104C along an axial axis of shaft 100, which allows handle 112 to create an impact on the end of endmost member 104C with sufficient force when pushed by an operator's hand to disengage friction locks 108.

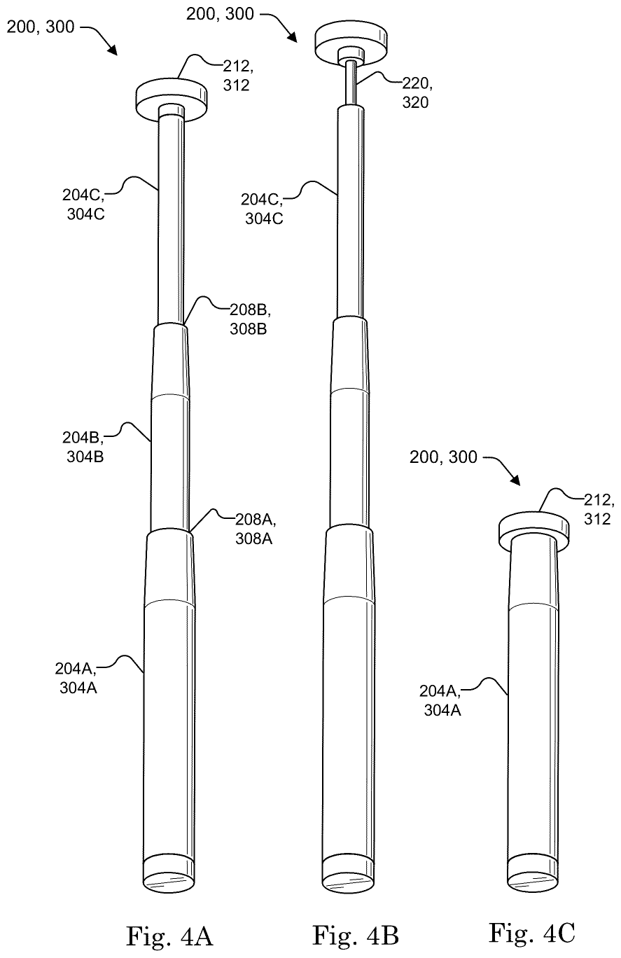

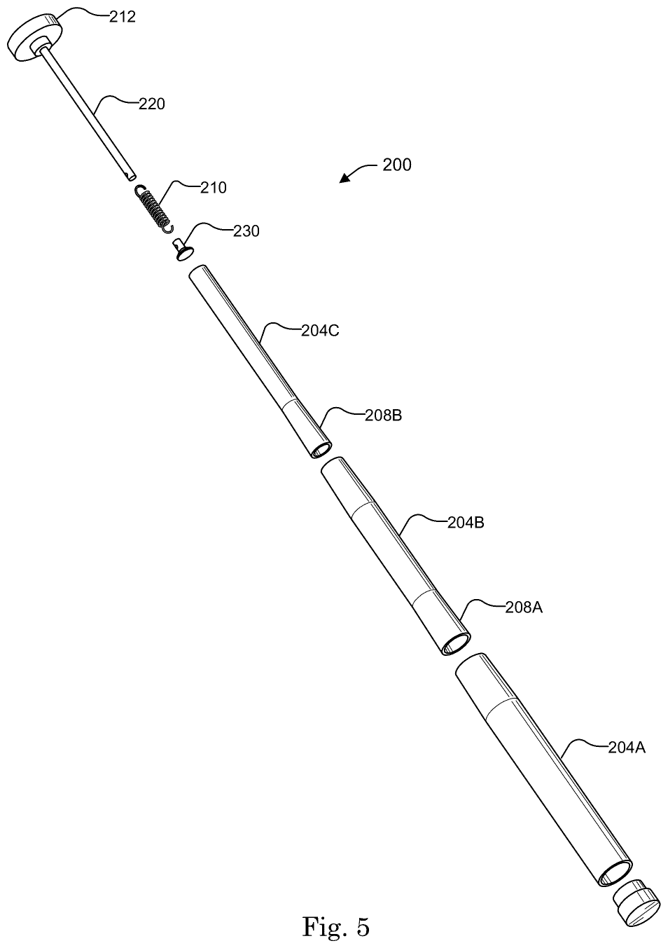

In another embodiment, FIGS. 4A-6C show a telescoping shaft 200 having a plurality of tubular members 204 (e.g., 204A-204C) that are held in an extended configuration by a plurality of friction locks 208 (e.g., 208A, 208B). Shaft 200 includes an object, such as a handle 212, at the end of an endmost member 204C.

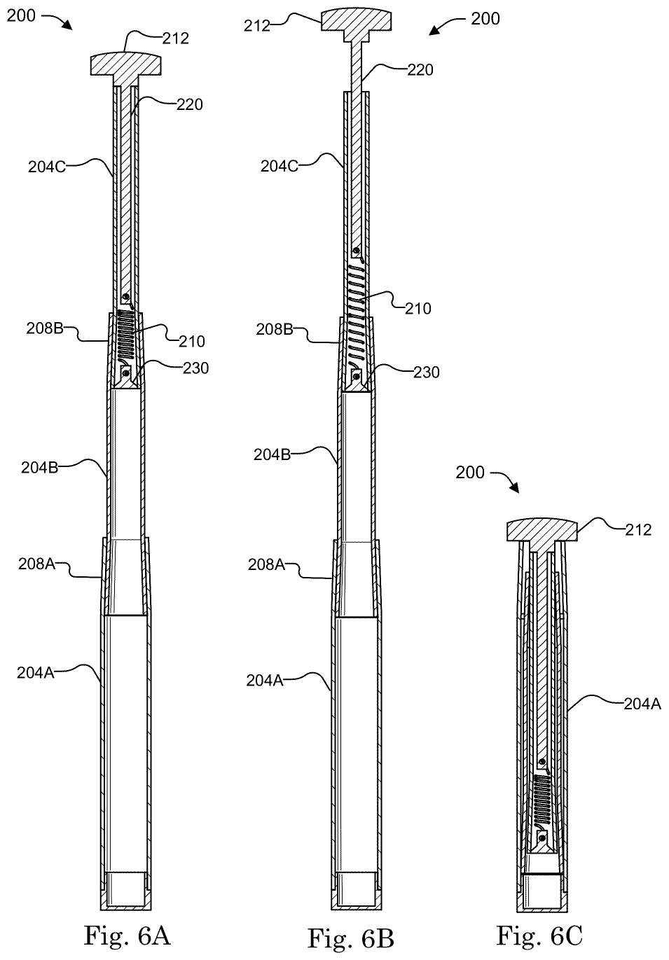

As can be seen in FIGS. 4A-4B, handle 212 is attached to a rod 220 that is extendable from and retractable into endmost member 204C along an axial axis. Rod 220 may also include a spring, such as a tension spring 210 (shown in FIGS. 6A-6C) configured to be extended from a spring anchor 230 connected to endmost member 204C when rod 220 is in an extended position. In this way, when rod 220 is extended outward from endmost member 204C along with attached handle 212, and rod 220 is then released, the force of tension spring 210 causes rod 220 to be retracted into endmost member 204C such that handle 212 will create an impact on the end of endmost member 204C with sufficient force to disengage friction locks 208.

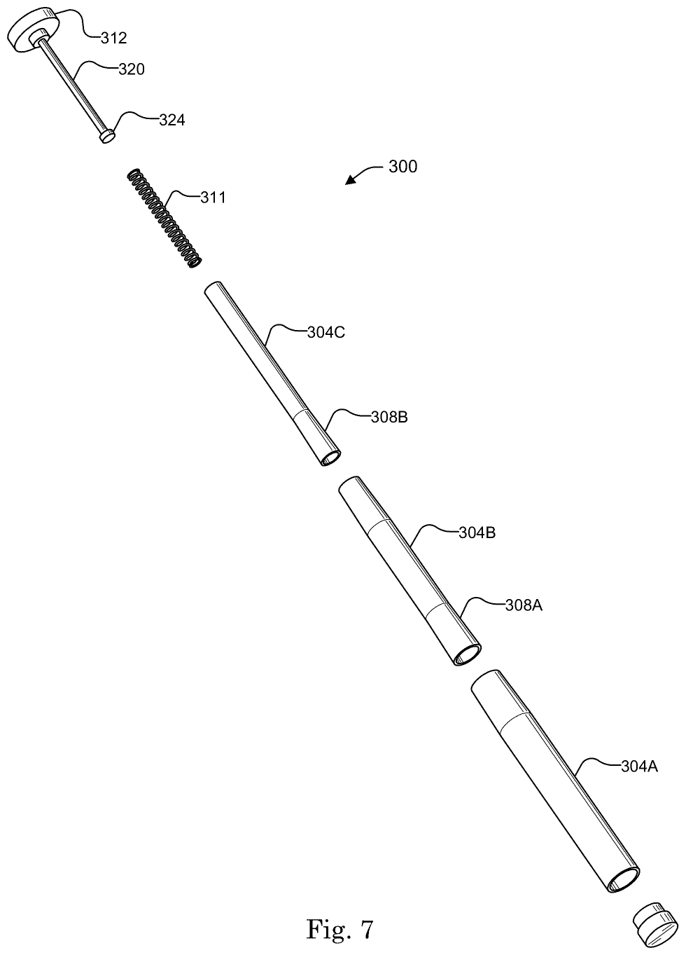

In another embodiment, FIGS. 4A-4C and 7-8C show a telescoping shaft 300 having a plurality of tubular members 304 (e.g., 304A-304C) that are held in an extended configuration by a plurality of friction locks 308 (e.g., 308A, 308B). Shaft 300 includes an object, such as a handle 312, at the end of an endmost member 304C.

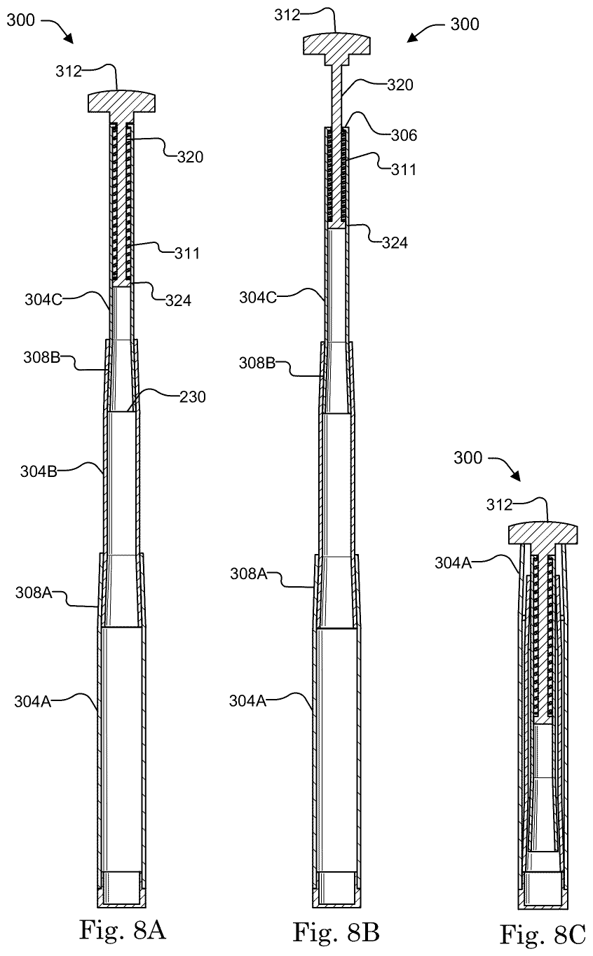

As can be seen in FIGS. 4A-4C, handle 312 is attached to a rod 320 that is extendable from and retractable into endmost member 304C along the shaft's longitudinal central axis. Rod 320 also includes a compression spring 310 having a portion 324 configured to engage with a narrow portion or ledge 306 of endmost member 304C when rod 320 is in an extended position (FIGS. 8A-8C). In this way, when rod 320 is extended outward from endmost member 304C along with attached handle 312, and rod 320 is then released, the force of spring 310 causes rod 320 to be retracted into endmost member 304C such that handle 312 will create an impact on the end of endmost member 304C with sufficient force to disengage friction locks 308.

Various modifications and additions can be made without departing from the spirit and scope of this disclosure. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve aspects of the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present disclosure.

What is claimed is:

1. A telescoping shaft having a collapsed configuration and an extended configuration, comprising:
a plurality of members forming the telescoping shaft, wherein each of the plurality of members are lockable in the extended configuration by a plurality of friction locks;
a rod configured to be received within an endmost member of the plurality of members, wherein the rod includes an extended position and a retracted position; and
an object attached to a distal end of the rod,
wherein, when the rod is moved from the extended position to the retracted position with sufficient rapidity, the object strikes the endmost member with sufficient force to unlock the plurality of friction locks.

2. The telescoping shaft of claim 1, further including a guide within the endmost member for receiving and guiding the rod.

3. The telescoping shaft of claim 2, wherein the rod includes a catch and the endmost member includes a receptor for the catch, and wherein, when the catch is engaged with the receptor, the rod is maintained in the retracted position.

4. The telescoping shaft of claim 1, further including a stop configured to prevent the rod from completely exiting the endmost member.

5. The telescoping shaft of claim 1, wherein the object has a mass selected to provide sufficient momentum when the rod is moved with sufficient speed from the extended position to the retracted position, to unlock the plurality of friction locks.

6. The telescoping shaft of claim 5, wherein the object is a handle.

7. The telescoping shaft of claim 5, wherein the object is a knob.

8. A telescoping shaft having a collapsed configuration and an extended configuration, comprising:
a plurality of members forming the telescoping shaft, wherein each of the plurality of members are lockable into the extended configuration by a plurality of respective friction locks;
a rod configured to be received within an endmost member of the plurality of members, wherein the rod includes a stop at a proximal end and wherein the rod includes an object attached to a distal end of the rod; and
a tension spring between the distal end and the proximal end of the rod,
wherein, when the rod is moved from a retracted position to an extended position, the stop engages with a portion of the endmost member and the tension spring stretches such that upon release, the rod moves into the endmost member to the retracted position causing the object to strike the endmost member with sufficient force to release the plurality of friction locks.

9. The telescoping shaft of claim 8, wherein the portion of the endmost member is at a distal end of the endmost member and includes a ledge configured to engage with the stop.

10. The telescoping shaft of claim 8, wherein the object has a mass selected to provide sufficient momentum when the rod is moved from the extended position to the retracted position due to retraction of the tension spring to unlock the plurality of friction locks.

11. The telescoping shaft of claim 8, wherein the object is a handle.

12. The telescoping shaft of claim 8, wherein the object is a knob.

13. A telescoping shaft having a collapsed configuration and an extended configuration, comprising:
a plurality of members forming the telescoping shaft, wherein each of the plurality of members are lockable into the extended configuration by a plurality of friction locks;
a rod configured to be received within an endmost member of the plurality of members, wherein the rod includes an object attached to a distal end of the rod; and
a compression spring between the distal end and a proximal end of the rod,
wherein, when the rod is moved from a retracted position to an extended position, the compression spring engages with a portion of the endmost member such that upon release, the rod moves into the endmost member to the retracted position causing the object to strike the endmost member with sufficient force to release the plurality of friction locks.

14. The telescoping shaft of claim 13, wherein the portion of the endmost member is at a distal end of the endmost member and includes a ledge configured to engage with the compression spring.

15. The telescoping shaft of claim 13, wherein the object has a mass selected to provide sufficient momentum when the rod is moved from the extended position to the retracted position due to release of the compression spring to unlock the plurality of friction locks.

16. The telescoping shaft of claim 13, wherein the object is a handle.

17. The telescoping shaft of claim 13, wherein the object is a knob.
